(19) United States
(12) Patent Application Publication
(10) Pub. No.: US 2024/0219227 A1
(43) Pub. Date: Jul. 4, 2024

(54) SENSORS WITH FAULT DETECTION

(71) Applicant: Allegro MicroSystems, LLC, Manchester, NH (US)

(72) Inventors: Solène Bastien, Annecy (FR); Andreas P. Friedrich, Metz-Tessy (FR)

(73) Assignee: Allegro MicroSystems, LLC, Manchester, NH (US)

(21) Appl. No.: 18/149,203

(22) Filed: Jan. 3, 2023

(51) Int. Cl. G01H 11/02; G01K 3/00; G01P 3/44; H02P 29/024

(52) U.S. Cl. CPC G01H 11/02; G01K 3/005; G01P 3/44; H02P 29/024

(57) ABSTRACT

According to some embodiments, a method for determining a fault status of a target system can include: receiving one or more magnetic field signals sensed by one or more magnetic field sensing elements of a sensor, the one or more magnetic field signals responsive to a magnetic field generated by a target object of the target system, the target object having repetitive motion; processing the one or more magnetic field signals to detect values of one or more parameters indicative of vibration of the target system; calculating deviations between the detected values and corresponding reference values of one or more parameters; determining a fault level of the target system based on the calculated deviations of one or more parameters; and generating an output signal indicating to the fault level.

### BACKGROUND

As is known, sensors are used to perform various functions in a variety of applications. Some sensors include one or more magnetic field sensing elements, such as a Hall effect element or a magnetoresistive element, to sense a magnetic field associated with proximity or motion of an object and to provide a signal (“magnetic field signal”) proportional to the magnetic field.

Some types of magnetic field sensors (sometimes referred to as rotation detectors) provide an output signal representative of the approach and retreat of each tooth of a rotating gear or of each segment of a segmented ring magnet (e.g., a ring magnet having segments with alternating polarities) as the gear or ring magnet rotates. The ferromagnetic gear/ring magnet may be referred to as the target object and the corresponding gear teeth/magnet segments may be referred to as target features. The system to which they belong may be referred to as the target system. The rotation detector can process the magnetic field signal to generate an output signal indicative of speed of rotation of the target object and, in some cases, also indicative of a direction of rotation and/or angular position of the target object.

Rotation sensors are commonly used within motor systems to sense speed, direction, and/or other motion of a motor. In some cases, a ferromagnetic gear or ring magnet can be affixed to a rotor, or to a shaft or gear driven by the rotor, and one or more magnetic field sensing elements and sensor circuitry can be positioned proximate thereto.

Sensor integrated circuits are widely used in automobile control systems, industrial machinery, and other safety critical applications. There are a variety of specifications that set forth requirements related to permissible sensor quality levels, failure rates, and overall functional safety.

Vibration analysis may be performed on motor systems and other types of systems that exhibit repetitive motion in order to detect changes (e.g., potential fault conditions) and prevent system failure. Existing solutions may involve an accelerometer placed on the target system and a frequency analyzer capable of detecting the harmonics of the system vibration signature. A change of the harmonics amplitude, harmonic frequency, and/or number of harmonics can indicate a change in the system such as alignment, tightening, bearing, or unbalanced fault. Available vibration analyzers output a frequency domain spectrum of the vibration signature and typically require additional analysis to determine the source of the change (e.g., misalignment vs. improper tightening).

### SUMMARY

Existing solutions for vibration analysis are complex in that an operator, technician, or other person must be trained in spectrum analysis and knowledgeable of which harmonic changes correspond to which potential fault conditions in the system. Existing solutions have generally been limited to use in industrial applications due to their high cost and training requirements.

Disclosed embodiments enable preventive maintenance of motor systems and other systems that exhibiting repetitive motion by automatically detecting deviations in one or more parameters indicative of system motion (referred to herein as “vibration signature parameters”).

Disclosed embodiments provide for target system fault detection within rotation sensors and other types of sensors. A sensor can be configured to detect values of one or more vibration signature parameters of a target object by analyzing one or more signals responsive to motion thereof (e.g., by analyzing one or more magnetic field signals). The sensor can calculate deviation between the detected values and reference values for the of one or more parameters and, based on the deviations, can generate an output signal indicating a fault level (or “warning level”) of the target system. The output signal can be received by an external system/device, such as an industrial maintenance box, to enable preventive maintenance of the target system. Disclosed embodiments provide for automatic calibration (“autocalibration”) of the reference parameter values, thereby eliminating the need for manual calibration by a trained person in the field.

Fault detection structures and techniques disclosed herein can be directly integrated into existing sensor integrated circuits (ICs)—such as speed sensors, angle sensors, rotation sensors, accelerometer-based vibration sensors, etc.—or implemented on a dedicated IC that interfaces with such existing sensors.

Disclosed embodiments can enable preventative maintenance of various types of industrial and commercial systems, including but not limited to automotive Advanced Driver Assistance Systems (ADAS).

Disclosed embodiments can be used to detect faults in various types of systems that exhibit repetitive motion, including but not limited to motor systems.

According to one aspect of the present disclosure, a method is provided for determining a fault status of a target system. The method can include: receiving one or more magnetic field signals sensed by one or more magnetic field sensing elements of a sensor, the one or more magnetic field signals responsive to a magnetic field generated by a target object of the target system, the target object having repetitive motion; processing the one or more magnetic field signals to detect values of one or more parameters indicative of vibration of the target system; calculating deviations between the detected values and corresponding reference values of one or more parameters; determining a fault level of the target system based on the calculated deviations of one or more parameters; and generating an output signal indicating to the fault level.

In some embodiments, the target system can include a motor system. In some embodiments, the target object can include a rotating shaft having a ring magnet to generate the magnetic field. In some embodiments, the target object can include rotating gear having ferromagnetic teeth to generate the magnetic field.

In some embodiments, the determining of the fault level of the target system can include comparing the calculated deviations of one or more parameters to corresponding predetermined threshold values. In some embodiments, the determining of the fault level of the target system can further include: determining the fault level of the target system to be a first fault level if none of the calculated deviations is greater than or equal to a corresponding predetermined threshold value; and determining the fault level of the target system to be a second fault level if at least one of the calculated deviations is greater than or equal to the corresponding predetermined threshold value. In some embodiments, at least one of the parameters may have two or more corresponding predetermined threshold values, wherein the determining of the fault level of the target system further includes: determining the fault level of the target system to be a first fault level if the calculated deviation of the at least one of the parameters is less than a first corresponding predetermined threshold value; determining the fault level of the target system to be a second fault level if the calculated deviation of the at least one of the parameters is greater than or equal to the first corresponding predetermined threshold value and less than a second corresponding predetermined threshold value; and determining the fault level of the target system to be a third fault level if the calculated deviation of the at least one of the parameters is greater than or equal to the second corresponding predetermined threshold value.

In some embodiments, the method can further include auto-calibrating the reference values of one or more parameters. In some embodiments, the auto-calibrating of the reference values can be responsive to a first startup of the sensor. In some embodiments, the auto-calibrating of the reference values can be responsive to a user command. In some embodiments, auto-calibrating the reference values of one or more parameters can include: processing the one or more magnetic field signals to detect the reference values of one or more parameters; and storing the reference values to non-volatile memory of the sensor. In some embodiments, the method can further include: receiving a signal responsive to a temperature of the sensor, wherein storing the reference values to non-volatile memory of the sensor is responsive to a determination that the temperature of the sensor is between a predetermined range of temperatures.

In some embodiments, the one or more parameters may include a parameter indicative of a speed of the target object, wherein the processing of the one or more magnetic field signals to detect the values of the one or more parameters includes: generating pulses responsive to amplitude of the one or more magnetic field signals; and incrementing a counter at a fixed rate between edges of the pulses to detect the speed of the target object.

In some embodiments, the receiving of the one or more magnetic field signals sensed by the one or more magnetic field sensing elements of the sensor can include receiving a first magnetic field signal sensed by a first magnetic field sensing element and receiving a second magnetic field signal sensed by a second magnetic field sensing element, wherein the one or more parameters include a parameter indicative of a phase difference between the first and second magnetic field signals, wherein the processing of the one or more magnetic field signals to detect the values of the one or more parameters includes: generating a first phase signal responsive to a phase of the first magnetic field signal; generating a second phase signal responsive to a phase of the second magnetic field signal; and calculating the phase difference between the first and second magnetic field signals based on a comparison of the first and second phase signals.

In some embodiments, the one or more parameters can include one or more parameters representing harmonics of the target system, wherein the processing of the one or more magnetic field signals to detect the values of the one or more parameters includes: transforming the one or more magnetic field signals into a frequency domain to determine the one or more parameters representing the harmonics of the target system. In some embodiments, the one or more parameters representing harmonics of the target system include: a number of the harmonics; frequencies of the harmonics; and amplitudes of the harmonics. In some embodiments, the one or more parameters include a parameter indicative of an amplitude of the one or more magnetic field signals.

According to another aspect of the disclosure, a sensor can include: one or more magnetic field sensing elements and a circuit configured to execute a process corresponding to any of the method embodiments just described.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram of an operating environment within which a sensor with integrated fault detection can be deployed for preventative maintenance of a target system, according to embodiments of the disclosure.

FIG. 2 is a diagram of a sensor configured to perform fault detection on a target system, according to embodiments of the disclosure.

FIG. 3 is a plot diagram illustrating a technique for detecting deviation in speed of a target object, according to embodiments of the disclosure.

FIG. 4 is a plot diagram illustrating a technique for detecting deviation in phase difference between two signals responsive to a target object, according to embodiments of the disclosure.

FIGS. 5A-5C and 6A-6C are plot diagrams illustrating techniques for detecting harmonic deviation of a target object, according to embodiments of the disclosure.

FIG. 7A is a plot showing how a vibration signature parameter can be tracked over multiple time periods and how multiple threshold values can be used for fault detection, according to embodiments of the disclosure.

FIG. 7B is a plot illustrating an output communication protocol that can be used to indicate a fault level of a target system, according to embodiments of the disclosure.

FIG. 8 is a flow diagram illustrating overall operation of a sensor with fault detection, according to embodiments of the disclosure.

FIG. 9 is a flow diagram illustrating a process for auto-calibrating reference parameter values used for fault detection, according to embodiments of the disclosure.

FIG. 10 is a flow diagram illustrating a process for detecting fault of a target system, according to embodiments of the disclosure.

The drawings are not necessarily to scale, or inclusive of all elements of a system, emphasis instead generally being placed upon illustrating the concepts, structures, and techniques sought to be protected herein.

### DETAILED DESCRIPTION

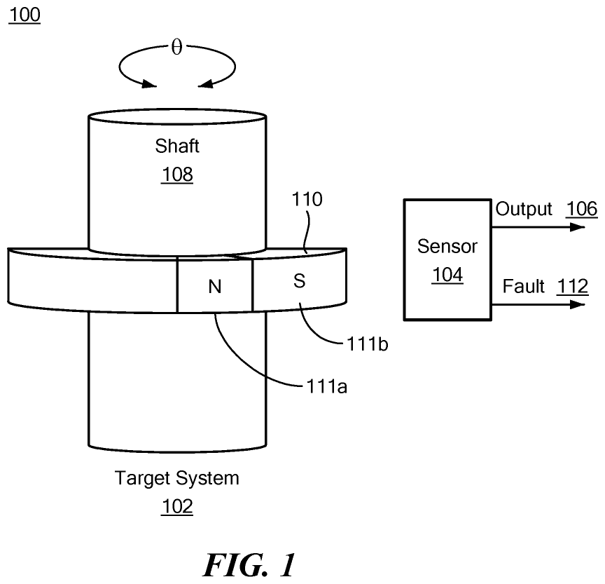

FIG. 1 shows an illustrative operating environment 100 in which embodiments of the present disclosure may be deployed. The operating environment 100 includes a target system 102 that exhibits repetitive motion (e.g., rotation), and a sensor 104 configured to provide an output signal 106 responsive to said motion (e.g., responsive to speed of rotation, direction or rotation, angular position, etc.).

In the example of FIG. 1, target system 102 is shown as having a rotatable shaft 108 and a ring magnet 110 affixed thereto. The ring magnet 110 can have a plurality of magnetic segments 111a, 111b, etc. (111 generally) arranged in alternating polarities. More generally, ring magnet 110 can have at least two segments 111 forming at least one pole pair (N-S), as shown. For the purpose of this disclosure, ring magnet 110 may be referred to as the target object and magnetic segments 111 may be referred to as target features. In other examples, a target system may include a ferromagnetic gear target where the gear teeth correspond the target features.

Sensor 104 can include one or more magnetic field sensing elements to sense a magnetic field generated by magnetic segments 111 as shaft 108 rotates. The magnetic field sensing elements can generate one or more magnetic field signals responsive to rotation of shaft 108. The magnetic field signal(s) can have sinusoidal waveforms, for example. Sensor 104 can include analog and/or digital circuitry configured to processes the magnetic field signal(s) and generate an output signal 106 that carries information about, for example, the shaft's speed of rotation, direction or rotation, and/or angular position.

As is known, there are different types of Hall effect elements, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

Sensor 104 may be further configured to execute one or more processes to detect a fault level of the target system 102 and, based thereon, to provide another output signal 112 (or “fault signal”) indicating a fault level of the target system 102. For example, sensor 104 may be configured to detect vibration of shaft 108, along with deviations in speed and harmonics of the shaft rotation. Based on such detections, sensor 104 can determine whether a potential defect/fault exists within target system 102 and in some cases, a level of severity associated with the determined defect/fault. In some cases, sensor 104 can use a binary communication protocol to indicate the fault level of the target system. For example, fault signal 112 may have a first level (e.g., voltage level or current level) indicating no fault within the target system 102 or a second level indicating fault. In other cases, sensor 104 can use a N-level (N>2) communication protocol. For example, fault signal 112 can have a first level indicating no fault, a second level indicating a low-severity fault, or a third level indicating a high-severity fault, where the distinction between “low” and “high” severity faults is determined according to one or more predetermined threshold values programmed or fixed within sensor 104.

A detailed description of structures and techniques for performing fault detection and generating fault signal 112 are described in detail below. Briefly, sensor 104 can process one or more magnetic field signals to detect values of one or more vibration signature parameters of the target system 102. Next, sensor can calculate how much the detected values deviate from known reference values for the parameters. Using the calculated deviations, sensor 104 can determine a fault level of the target system 102 and generate fault signal 112 indicative thereof. In some cases, sensor 104 may be configured to auto-calibrate the reference parameter values and store them in non-volatile memory for later use.

Output signals 106 and 112 may carry information in the form of differing voltage levels, differing current levels, or both. In some cases, output signals 106 and 112 may be provided at separate terminals/ports, such as illustrated in FIG. 1. In other cases, they may be provided at common terminal/port. For example, signals 106, 112 may be analog signals superimposed onto each other, where fault signal 112 is set to a level such that it can be distinguished from output signal 106. As another example, signals 106, 112 may be digital signals communicated using an output protocol that allows fault signal 112 to be decoded separate from output signal 106.

In some embodiments, sensor 104 may be provided as a conventional sensor that is adapted (e.g., reprogrammed or otherwise reconfigured) to perform disclosed fault detection functions, including autocalibration. For example, digital and/or analog processing circuitry for perform disclosed fault detection functions may be added to a conventional rotation detector operable to detect speed or rotation, direction of rotation, and/or angular position or shaft 108 with ring magnet 110. In some embodiments, disclosed fault detection functions can be implemented on a dedicated IC that interfaces with various types of existing sensors. For example, sensor 104 may include a first integrated circuit (IC) that provides conventional rotation detection circuitry and a second IC that implements disclosed fault detection functions, wherein the two IC's interface with each other, e.g., via an Inter-Integrated Circuit (I2C) interface or a CAN (Controller Area Network). The two IC's may be provided on the same die or on separate dies.

In some embodiments, environment 100 can include multiple sensors and at least one of the sensors can be configured to perform disclosed fault detection functions. In some cases, multiple sensors may be configured perform fault detection.

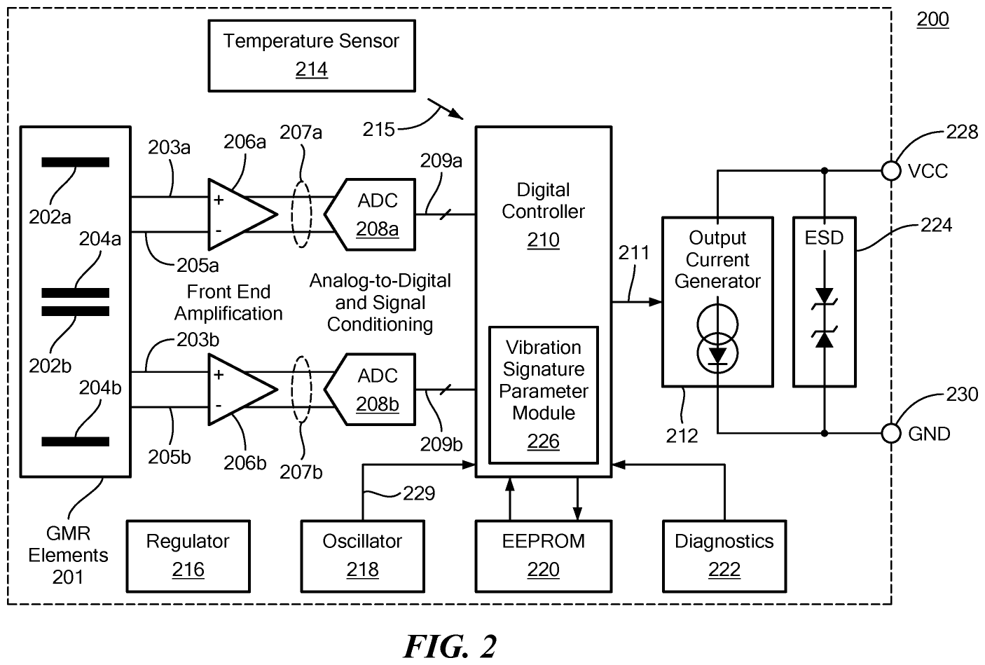

Turning to FIG. 2, an illustrative sensor 200 can be configured to perform fault detection on a target system, according to embodiments of the disclosure. For example, sensor 200 may be the same as or similar to sensor 104 of FIG. 1. In the example of FIG. 2, sensor 200 is provided as a rotation sensor adapted to perform fault detection. Alternative implementations are possible in which sensor 200 is provided as a position sensor and/or any other suitable type of magnetic field sensor.

Illustrative sensor 200 may include a plurality of magnetic field sensing elements 201, a first channel including a first amplifier 206a and a first analog-to-digital converter (ADC) 208a, a second channel including a second amplifier 206b and a second ADC 208b, a digital controller 210, and an output current generator 212. Sensor 200 may also include a temperature sensor 214, a regulator 216, an oscillator 218, non-volatile memory 220, an internal diagnostic circuit 222, and an electrostatic discharge (ESD) circuit 224.

In the example of FIG. 2, magnetic field sensing elements 201 (or “sensing elements” for short) can four magnetic field sensing elements with two sensing elements 202a, 204a provided as part of the first channel and the other two sensing elements 202b, 204b provided as part of the second channel. However, the structures and techniques disclosed here can be utilized with sensors that have other numbers and arrangements of sensing elements. In some embodiments, sensing elements 201 can include GMR elements. In other embodiments, sensing elements 201 can include Hall elements or TMR elements. The present disclosure is not limited to any specific implementation of the sensing elements 201.

Digital controller 210 (or “controller” for short) may include any suitable type of processing circuitry. In some implementations, controller 210 may include a general-purpose processor, an application-specific processor, and/or any other suitable type of processing circuitry. Non-volatile memory 220 may include an Electrically Erasable Programmable Read-Only Memory (EEPROM) and/or any other suitable type of non-volatile memory. Controller 210 may include, or otherwise have access to, a volatile memory (not shown) which can include a Dynamic Random-Access Memory (DRAM) and/or any other suitable type of volatile memory.

During operation, in the first channel, sensing elements 202a and 204a may generate signals 203a and 205a, respectively. First amplifier 206a may amplify signals 203a and 205a to produce a first amplified signal 207a. First ADC 208a may digitize first amplified signal 207a to produce a first digital signal 209a. In the second channel, sensing elements 202b and 204b may generate signals 203b and 205b, respectively, and second amplifier 206b may amplify signals 203b and 205b to produce a second amplified signal 207b. Second ADC 208b may digitize second amplified signal 207b to produce a second digital signal 209b. As shown, amplified signals 207a and 207b may correspond to differential signals produced by amplifiers 206a and 206b, respectively. In some cases, first digital signal 209a may be responsive to a difference between magnetic field signals generated by sensing elements 202a and 202b, and second digital signal 209b may be responsive to a difference between magnetic field signals generated by sensing elements 204a and 204b.

Amplified signals 207a, 207b and corresponding digital signals 209a, 209b may have sinusoidal waveforms, with a phase offset therebetween. In general, the value of the phase offset between internal magnetic field signals (such as the signals 209a and 209b) of a sensor depends on the dimensions of the target object whose movement the sensor is used to detect, in addition to the placement and orientation of the individual magnetic field sensing elements (e.g., sensing elements 202a, 204a, 202b, 204b). The sinusoidal signals may have a frequency determined by the number target features on the target object being sensed, such as the number of pole pairs on ring magnet 110 of FIG. 1.

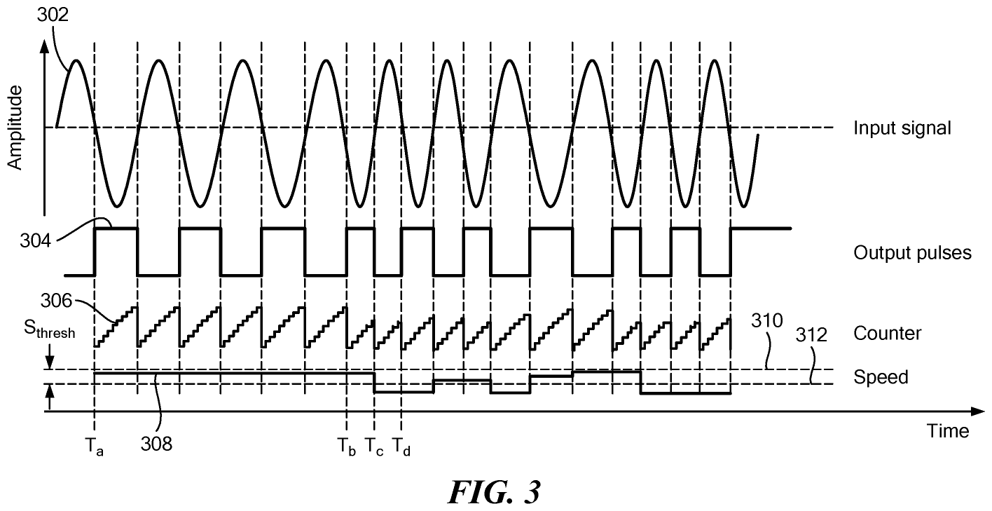

Controller 210 can receive and process digital signals 209a, 209b to generate a signal 211 indicative of the speed of rotation, direction of rotation, and/or angular position of a target object (e.g., a shaft with ring magnets, such as shaft 108 of FIG. 1, a ferromagnetic gear, etc.). For ease of explanation, signal 211 is referred to herein as a “rotation signal.” Controller 210 may implement and utilize any suitable techniques to generate rotation signal 211. As one example, a technique for generating a signal responsive to rotation speed is described below in the context of FIG. 3.

In some embodiments, controller 210 may use a phase offset between digital signals 209a, 209b to generate rotation signal 211. For example, controller 210 may use the phase offset to determine a direction of the target object and generate rotation signal 211 in a manner that indicates the determined. In some embodiments, the phase offset may be set in the factory and stored in non-volatile memory 220, where it can be accessed and used by controller 210 during operation. In other embodiments, controller 210 may automatically calculate the phase offset between digital signals 209a, 209b at startup and, in some cases, at other times during operation. The calculated phase offset may be stored in volatile memory and/or non-volatile memory and used to dynamically generate rotation signal 211.

In some embodiments, controller 210 may determine direction of rotation based on the order of rising and falling edges within pulse signals generated from digital signals 209a, 209b. In more detail, controller 210 can generate a first pulse signal based on first digital signal 209a, a second pulse signal based on second digital signal 209b, and can compare the relative order of pulse between these two signals to determine direction of rotation (a change in order indicates a change in direction). An example of a pulse signal that can be generated for this purpose is illustrated below in the context of FIG. 3. Controller 210 can generate rotation signal 211 in a manner that indicates the determined direction or rotation.

Rotation signal 211 may be encoded to indicate the information about the target object. For example, rotation signal 211 may be a pulse-encoded signal, where the pulse widths, pulse heights, spacing between pulses, etc. may be varied to indicate speed of rotation, direction of rotation, and/or angular position of the target object. Various other output communication protocols may be used with rotation signal 211.

As shown in FIG. 2, rotation signal 211 may be provided to output current generator 212 which is connected between a first terminal 228 and a second terminal 230 of the sensor. The first terminal 228 can be coupled to a power supply voltage (VCC) and the second terminal 230 can be coupled to a fixed voltage source, for example, a ground voltage source (GND). Thus, in some arrangements, sensor 200 can be a two terminal device (or two wire device), for which an output signal appears as a signal current at first terminal 228 superimposed upon a low signal sensor current draw from the power supply voltage (VCC)

In other embodiments, a sensor similar to sensor 200 may be provided as a three terminal (three wire device) that has a third terminal (not shown) at which an output signal can appear as a voltage rather than a current. In such arrangements, output current generator 212 may be omitted and rotation signal 211 may be output via a different interface, such as an I2C interface or a CAN. In this regard, it will be understood that the present disclosure is not limited to using any specific interface for outputting rotation signal 211.

In addition to using digital signals 209a, 209b to generate rotation signal 211, controller 210 can use digital signals 209a, 209b to perform automated fault detection of the target system, according to the present disclosure. In more detail, controller 210 can include a vibration signature parameter (VSP) module 226 comprising processing circuitry configured to detect values of one or more vibration signature parameters of the target system by analyzing one or both of digital signals 209a, 209b. VSP module 226 can then calculate deviations between the detected values and reference values for the parameters to determine when a change in the target system, possibly the result of a fault/defect that requires maintenance.

In some embodiments, VSP module 226 can detect one or more of the following vibration signature parameters (or “parameters” for short) of a target system:
1. speed of the target object (e.g. rotation speed);
2. phase difference between digital signals 209a, 209b;
3. a number of harmonics within digital signal 209a and/or 209b;
4. frequencies of the harmonics;
5. amplitudes of the harmonics; and
6. amplitude of digital signal 209a and/or 209b.

Tcchniques for detecting values of each of the aforementioned parameters are described in detail below.

For each vibration signature parameter, VSP module 226 can determine if the deviation between the detected value and the reference value is greater than (or in some cases less than) one or more predetermined threshold values associated with that parameter. In some embodiments, a parameter's deviation may be calculated as a percentage, as follows:

$${deviation}_{pct} = ( {p}_{ref} - {p}_{det} ) / {p}_{ref} \times 100 \qquad ( 1 )$$

where p_{ref} is the reference value and p_{det} is the detected value for the parameter. In this case, the corresponding threshold value may also be expressed and stored as a percentage.

Based on comparing a given parameter deviation to one or more predetermined threshold values, VSP module 226 can determine a fault level of the target system and generate an output indicative thereof. For example, if all of the parameters deviate by less than their respective threshold values, VSP module 226 may determine a first fault level corresponding to a no-fault condition. Otherwise, if any of the parameters deviate by an amount greater than or equal to their respective threshold values, VSP module 226 may determine a second fault level corresponding to a fault condition. In other embodiments, sensor 200 may output multiple fault levels corresponding to multipole different parameters. In some embodiments, sensor 200 may be programmed (e.g., via EEPROM) to output a single fault level versus multiple fault levels.

In some cases, for a given parameter, VSP module 226 may use a given threshold value to provide both an upper and lower bound on the parameter's deviation. For example, VSP module 226 may calculate the deviation as an absolute value prior to comparing it to the threshold value such that sufficiently large parameter deviation in either the positive or negative directions can lead to a fault detection. In other cases, separate positive and negative threshold values can be defined for a given parameter, and VSP module 226 indicate a fault if the calculated deviation is greater than the positive threshold value or less than the negative threshold value.

In some embodiments. VSP module 226 may compare a parameter's deviation to multiple threshold values (e.g., two or more different threshold values) and, based on these comparisons, can determine an N-level fault level associated with the target system (e.g., no-fault, fault level 1, fault level 2, etc.).

In some cases, parameter threshold values may be fixed (or “hardcoded”) within VSP module 226 at the time of manufacture. In other cases, threshold values may be stored within non-volatile memory 220 by external means, e.g., programming, either at the time of manufacture or at a later time (e.g., by a technician in the field).

In some embodiments, VSP module 226 can include circuitry configured to auto-calibrate the reference values in response to certain events, such as when sensor 200 first powers on and/or in response to a user command (“autocalibration command”). VSP module 226 can store the auto-calibrated reference values in non-volatile memory 220 such that they are available for use the next time the sensor 200 is powered on. In some embodiments, sensor 200 can include an input port via which autocalibration can be initiated in response to receiving an autocalibration command (e.g., a voltage level applied via an industrial maintenance box or other external system/device). In some embodiments, sensor 200 may be provided within an IC package and the input port for receiving an autocalibration command may correspond to a pin of the IC package.

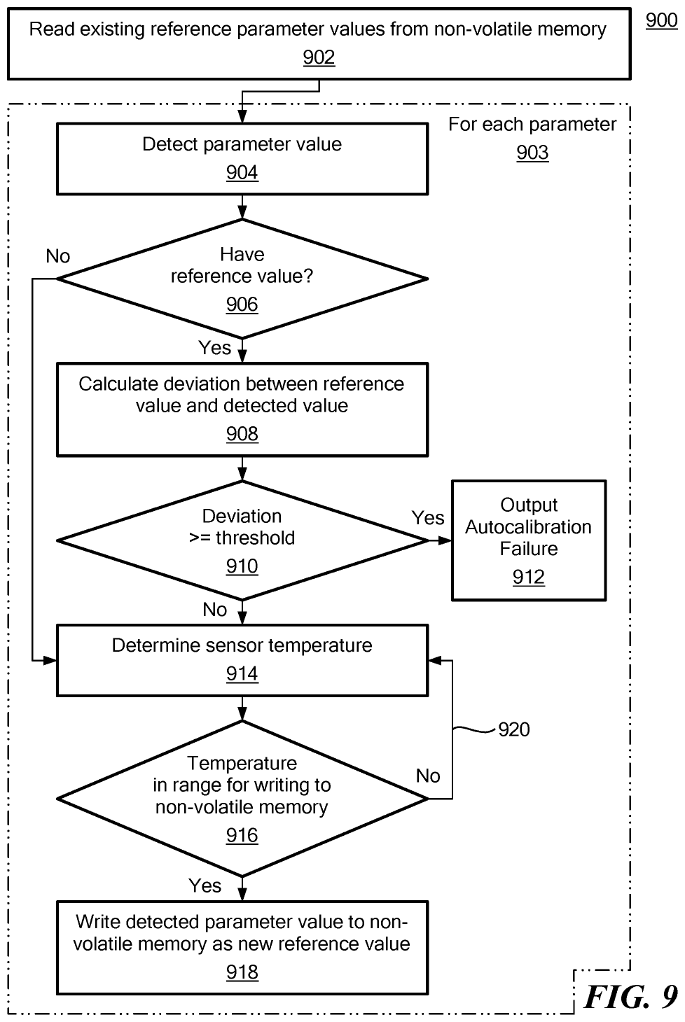

In some embodiments, as a safeguard, VSP module 226 may perform bounds checking on new reference values detected during autocalibration. In particular, if a newly detected reference value deviates from a previous reference by more than a threshold value, VSP module 226 may disregard the new reference value and, in some cases, provide an output indicating an autocalibration failure (e.g., to a maintenance box connected to terminal 228 or a fault pin of an IC on which sensor 200 is provided). In some cases, VSP module 226 can use a temperature signal 215 from temperature sensor 214 to determine if autocalibration can be performed. Tcmperature signal 215 may have a voltage/current level responsive to temperature of the sensor 200. These and other details of autocalibration are discussed further below in the context of FIG. 9.

VSP module 226 can use a clock signal 229 generated by oscillator 218 (e.g., a clock oscillator) to detect one or more of the vibration signature parameters discussed herein. For example, VSP module 226 can implement a counter to detect speed of rotation of the target object using, where the counter increments at a rate determined by clock signal 229. In general, oscillator can be provided as any type of circuit configured to generate a signal having a stable reference frequency.

Various output communication protocols and interfaces may be used to communicate a fault level of the target system, as determined by VSP module 226, to an external system/device, such as an industrial maintenance box. For example, VSP module 226 may generate an output signal having a voltage and/or current level indicative of the determined fault level (e.g., no-fault, fault level 1, fault level 2, etc.). This output signal can be provided at a third terminal (not shown) of sensor 200 or, in some cases, may be superimposed upon a low signal sensor current draw from the power supply voltage (VCC) by output current generator 212 and provided at first terminal 228. As another example, VSP module 226 may write a value corresponding to the fault level to memory wherein it can be read back via a maintenance box connected to an output of the sensor. In some embodiments, sensor 200 may provide a digital output interface such as an I2C interface or a CAN via which an external system/device can read the fault level. Other output communication interfaces can be used, and the present disclosure is not limited to using any specific interface for outputting a determined fault level. In any case, an external system/device can be connected to sensor 200 to obtain the fault level automatically determined by sensor 200, thereby enabling preventative maintenance of the target system.

Turning to FIG. 3, and with continued reference to FIG. 2, according to some embodiments VSP module 226 can use target object's speed (e.g., rotation speed) as a vibration signature parameter for fault detection. Many systems may operate at a relatively constant speed or within a fixed range of speeds. As such, a significant deviation in speed can indicate a fault/defect with the system.

An input signal 302 may correspond to either digital signal 209a or digital signal 209b of FIG. 2. That is, in the case of a multi-channel sensor, rotation speed can be detected using a signal from any given channel. Input signal 203 can have a sinusoidal waveform with a frequency responsive to the target object's speed.

VSP module 226 can calculate a pulse signal 304 having pulse widths proportional or otherwise responsive to the frequency of the input signal 302 and, thus, to the target object's speed. In the example of FIG. 3, input signal 302 has have a first frequency between times Tₐ and T_{b} and pulse signal 304 has pulses of a first width during this period. Between times T_{b} and T_{d}, input signal 302 has a second, higher frequency and pulse signal 304 has pulses of a second, narrower width. To generate pulse signal 304, VSP module 226 can compare the instantaneous amplitude of input signal 302 against a threshold amplitude value corresponding to a predetermined percentage (e.g., 50%) of the maximum amplitude of input signal 302. In some embodiments, this predetermined percentage may be a programmable setting of the sensor and stored within EEPROM or other non-volatile memory. In other embodiments, the predetermined percentage may be fixed/hardcoded within the sensor. In any case, VSP module 226 may calculate the threshold amplitude by detecting the maximum amplitude of input signal 302 and multiplying it by the predetermined percentage.

When the instantaneous amplitude exceeds the threshold amplitude value, VSP module 226 can transition pulse signal 304 from a low value (e.g., zero voltage) to a high value (e.g., non-zero voltage), producing a rising pulse edge. When the instantaneous amplitude falls below the threshold amplitude value, VSP module 226 can transition pulse signal 304 from the high value to the low value, producing to a falling pulse edge. The percentage used for determining the threshold amplitude value may be a fixed or programmed within the sensor.

VSP module 226 can generate a counter signal 306 that indicates elapsed time between rising and falling edges of pulse signal 304. In more detail, VSP module 226 can implement a counter that increments at a fixed rate (e.g., according to clock signal 229) and that resets to zero at each rising and falling edge of pulse signal 304. The value of the counter just prior to being reset may be inversely proportional or otherwise responsive to the frequency of the input signal 302. In the example of FIG. 3, between times Tₐ and T_{b}, counter signal 306 reaches a first value just before being reset, indicating a first frequency. Between times T_{b} and T_{d}, counter signal 306 reaches a second, lower value just before being reset, indicating a second, higher frequency. Because counter signal 306 increments at a rate based on an internal clock (e.g., oscillator 218), the minimum detectable speed may be limited by the counter digital block dimensions. Thus, in some cases (e.g., for relatively low speed applications), VSP module 226 may increment counter signal 306 at a rate less than that of the internal clock signal (e.g., once for every 2, 3, 5, 10, 25, 100, etc. ticks of the internal clock).

VSP module 226 can generate a speed signal 308 having a level (e.g., voltage or current level) corresponding to the highest value of counter signal 306, and can hold this value between edges of the pulse signal 304. In the example of FIG. 3, between times Tₐ and T_{c}, speed signal has a first value corresponding to the highest value of counter signal 306 between times Tₐ and T_{b}. The next pulse edge occurs at time T_{c}, at which point speed signal 308 takes a second, lower value corresponding to the highest value of counter signal 306 between times T_{b} and T_{c}. Thus, as can be seen, the level of speed signal 308 increases as the input signal 320 frequency decreases, and decreases as the input signal 320 frequency increases.

VSP module 226 can use speed signal 308 to detect when the target object speed deviates from a reference speed value, indicated by line 310. In particular, predetermined threshold value, Sₜₕᵣₑₛₕ, set for the speed parameter can be used to establish an upper bound on the target object speed, indicated by line 312. If the level of speed signal 308 falls below that of line 312, VSP module 226 can detect a fault condition related to the target object speed and generate an output indicating an appropriate fault level. In the example of FIG. 3, VSP module 226 may be configured to detect when the speed of the target object exceeds the upper bound represented by line 312. In some embodiments, VSP module 226 may alternatively or additional be configured to detect when the target object speed falls below a lower bound, which would be represented by a line that lies above the reference speed value (i.e., above line 310). In some embodiments, the upper and lower bounds may be based on different predetermined threshold values, e.g., S_{thresh_upper} and S_{thresh_lower}.

In some embodiments, VSP module 226 can check for speed deviation over multiple periods of input signal 302. For example, if the speed deviates by more than the threshold value Sₜₕᵣₑₛₕ for C consecutive periods, then VSP module 226 may signal a fault. This same approach can be used for any of the vibration signature parameters discussed herein.

The above-described technique for speed detection is merely one example and other speed detection techniques can be utilized for fault detection according to the present disclosure.

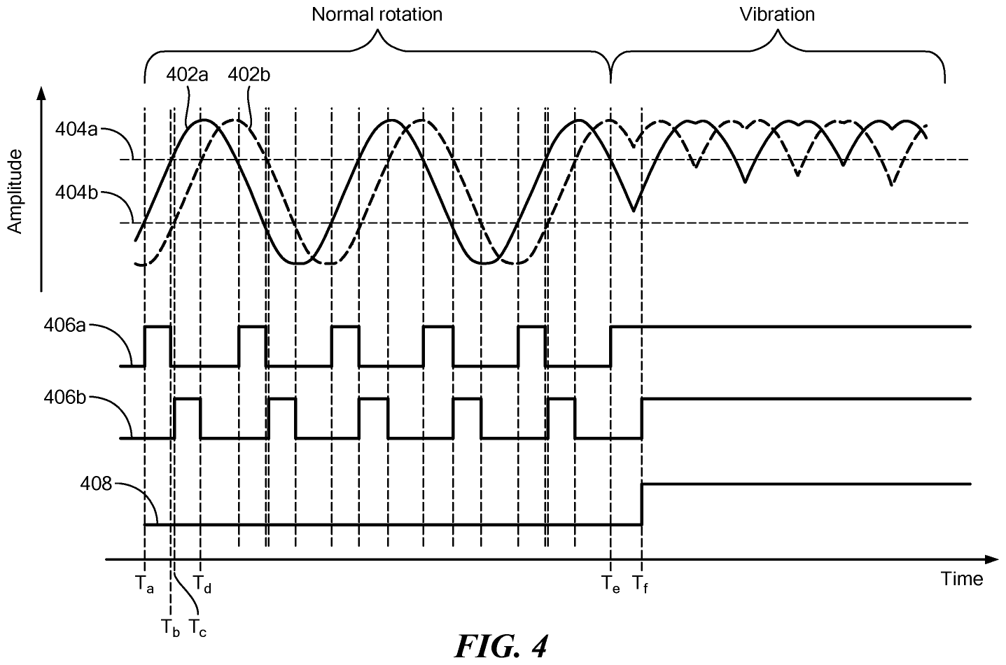

Turning to FIG. 4, and with continued reference to FIG. 2, according to some embodiments VSP module 226 can detect deviation in phase difference between two input signals 402a, 402b obtained from two different channels of a sensor having a plurality of magnetic sensing elements. Input signals 402a and 402b may correspond to, for example, digital signals 209a and 209b of FIG. 2, respectively.

As previously discussed, the phase offset between internal magnetic field signals of a sensor depends on the dimensions and/or geometry of the target object (e.g., target pitch) whose movement the sensor is used to detect, in addition to the placement and orientation of the individual magnetic field sensing elements (e.g., sensing elements 202 of FIG. 2). The sensing elements may be arranged and positioned in relation to the target object such that, during normal operation, input signals 402a, 402b have a known phase difference (e.g., 90°). If there is excess vibration in the target system, the phase difference between input signals 402a, 402b may change (e.g., to be less than 90° or greater than 90°). Thus, according to some embodiments, phase difference can be used as a vibration signature parameter for fault detection. In the example of FIG. 4, it is assumed that the target object experiences no vibration or minimum vibration during the period from time Tₐ to time T_{c}, and experiences excess vibration starting at time T_{c}.

VSP module 226 can calculate a first phase signal 406a and a second phase signal 406b responsive to a phase of a first input signal 402a and a second input signal 402b, respectively. Phase signals 406a, 406b may also be referred to as “phase flags.” First phase signal 406a can have pulses during periods of time when first input signal 406a has an amplitude in the range defined by first and second predetermined threshold levels 404a, 404b. More specifically, first phase signal 406a can have a first voltage/current level when the amplitude of first input signal 402a is outside of the threshold range and take have a second, higher voltage/current level when the amplitude of first input signal 402a is within the threshold range. For example, as shown in FIG. 4, first phase signal 406a has a pulse between the period Tₐ to T_{c} when the first input signal 402a amplitude is within the range defined by threshold levels 404a, 404b.

Likewise, second phase signal 406 can have pulses during periods of time when second input signal 406b has an amplitude in the range defined by first and second predetermined threshold levels 404a, 404b. For example, as shown in FIG. 4, second phase signal 406b has a pulse between the period T_{c} to Tₐ when the second input signal 402b amplitude is within the threshold range.

Thus, in the example of FIG. 4, during normal operation between times Tₐ and Tₑ, phase signals 406a, 406b may not overlap, or may have substantially no overlap. In contrast, starting around time T_{f}, phase signals 406a, 406b begin to substantially overlap. Of note, while the target system experiences vibration starting at time Tₑ, there may be a delay (T_{f}−Tₑ) before phase signals 406a, 406b overlap, corresponding to the time it takes for phase signal 406b to change from high to low based on input signal 402b.

In some embodiments, threshold levels 404a, 404b may be programmable and stored within non-volatile memory. In other embodiments, threshold levels 404a, 404b may be fixed/hardcoded within the sensor.

VSP module 226 can calculate a vibration detection signal 408 from the two phase signals 406a, 406b. In some digital implementations, VSP module 226 can perform a NAND (NOT-AND) operation on phase signals 406a, 406b to calculate vibration detection signal 408. In more detail, a phase signal can be treated as binary signal that has a value of zero (0) at times when there is no pulse and has a value of one (1) when there is a pulse. Thus, if both phase signals 406a, 406b have a pulse (i.e., value of 1), the vibration detection signal 408 also has a value of one (1) and otherwise has a value of zero (0). Here, zeros and ones can correspond to different voltage/current levels. Thus, in the example of FIG. 4, vibration detection signal 408 has a first value during the period Tₐ to T_{f} and has a second, higher value starting at time T_{f}.

VSP module 226 can detect a fault (excess vibration) when vibration detection signal 408 has the second, higher value.

FIG. 4 illustrates one technique for using phase difference between two input signals to detect a vibration signature parameter. As another example, phase between two input signals can be calculated using a fast Fourier transform (FFT) over at least one period using, for example, techniques described in US Pat. Pub. No. 2022/0317142 filed on Mar. 30, 2021, and entitled “Automatic Phase Offset Calculation.” With this approach, VSP module 226 can establish a reference value by detecting phase difference during autocalibration and store the reference value in non-volatile memory. At a later time, VSP module 226 can calculate deviation from the reference value and compare the deviation to a threshold value to detect a fault with the target system.

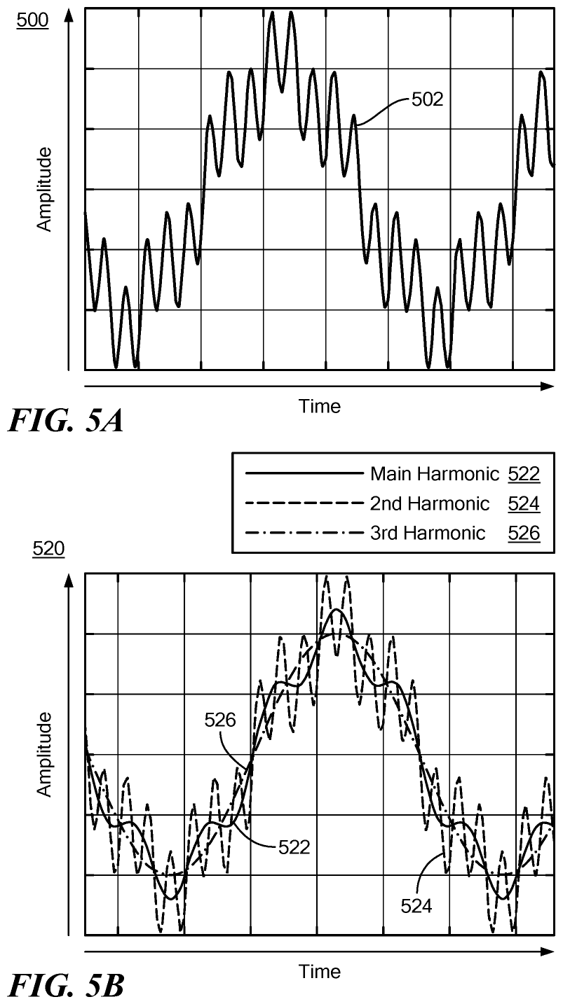

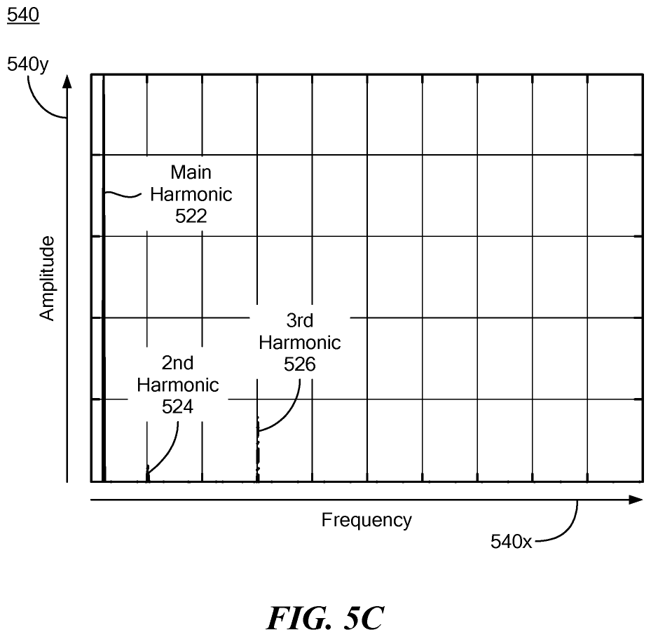

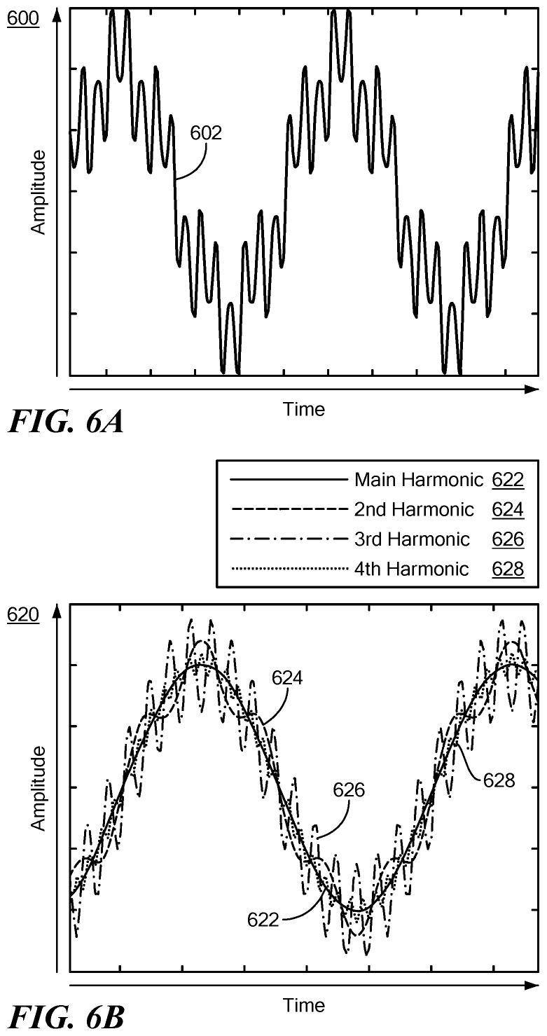

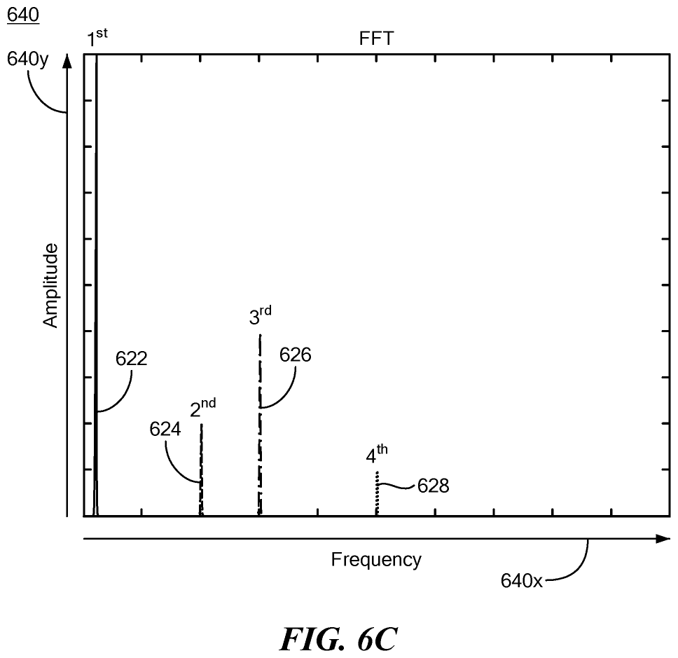

FIGS. 5A-5C and 6A-6C illustrate techniques for detecting harmonic deviation of a target object, according to embodiments of the disclosure. It is appreciated herein a change of the number of harmonics, harmonic frequencies, and/or harmonic amplitudes, may indicate a fault within a target system. For example, in the case of a motor system, harmonic deviation may indicate a problem with the rotor, such as misalignment, improper tightening, imbalance, or another potential fault condition.

In general, vibration of a target system can be expressed as sum of harmonics, as follows:

$${V}_{s y s} = {A}_{1} sin ( 2 π {f}_{0} t ) + {A}_{2} sin ( 2 π {f}_{0} t \times n ) + {A}_{3} sin ( 2 π {f}_{0} t \times ( n + 1 ) ) + … \qquad ( 2 )$$

where Aᵢ is the harmonic amplitude of the i^{th} harmonic, f₀ is a reference frequency, n is a factor of f₀, and tis time.

Referring to plot 500 of FIG. 5A, amplitude of an illustrative input signal 502 is shown plotted over time. Input signal 502 may be an internal magnetic field signal responsive to repetitive motion of a target object. For example, input signal 402 may correspond to digital signal 209a or 209b of FIG. 2. In some cases, input signal 502 may be obtained in response to rotation of a shaft or gear within a motor system. However, the disclosed techniques for detecting harmonic deviation may be applied to other types of target objects and/or other types of repetitive motion.

As shown, input signal 502 may overall have a sinusoidal-like waveform, but deviate in amplitude from a pure sinusoidal as a result of vibration of the target system/object. Many real-world systems will exhibit some amount of vibration during normal operation and thus, for example, a signal waveform such as shown in FIG. 5A may be expected/normal for a given target system. However, changes in an input signal's waveform may indicate a potential fault condition with the target system.

Input signal 502 can be represented by (or “broken down”) into multiple harmonics, as illustrated by plot 520 of FIG. 5B. In the example shown, input signal 502 is broken down into three harmonics (represented in the figure as time-domain signals): a main harmonic 522, a second harmonic 524, and a third harmonic 526. Of note, the main harmonic 522 has a sinusoidal waveform, in contrast to the two other harmonics 524, 526. It will be appreciated that, while three (3) harmonics are shown in the example of FIG. 5B, other numbers of harmonics may be detected (e.g., 4 or 5 harmonics), and that the particular harmonics detected may vary depending on how the FFT digital implementation.

Turning to FIG. 5C, in some embodiments, VSP module 226 can utilize an FFT to detect the frequencies and amplitudes of an input signal's harmonics. That is, VSP module 226 can utilize an FFT to convert a time-domain input signal into a frequency-domain plot showing the frequencies and amplitudes of the harmonics of the input signal (i.e., to separate the input signal by frequency components). FIG. 5C shows the three harmonics 522, 524, 526 of FIG. 5B represented on a frequency-domain plot 540, in which horizontal axis 540x represents frequency and vertical axis 540y represents amplitude. It can be seen that main harmonic 522 has significantly higher amplitude than the other two harmonics 524, 526, as might be expected.

Using a plot such as plot 540, VSP module 226 can determine one or more of the following vibration signature parameter values: (1) the number of harmonics of the input signal 502, (2) frequencies of the harmonics, and (3) amplitudes of the harmonics. VSP module 226 can detect one of more of these parameter values, calculate deviations from a corresponding reference parameter value, and compare these deviations to threshold values to determine if a fault exists.

FIGS. 6A-6C, contrasted with FIGS. 5A-5C, illustrate how harmonic deviations of an input signal can be used for fault detection, according to the embodiments of the present disclosure.

FIG. 6A shows an input signal 602 that may be obtained in response to the same target object as for input signal 502 in FIG. 5A, but over a different period of time. For example, input signal 502 in FIG. 5A may be obtained responsive to a motor system during a first period and input signal 602 in FIG. 6A may be obtained responsive to the same motor system during a second, later period.

FIG. 6B shows input signal 602 is broken down into four harmonics (represented in the figure as time-domain signals): a main harmonic 622, a second harmonic 624, a third harmonic 626, and a fourth harmonic 628, where the main harmonic 622 is sinusoidal.

FIG. 6C shows how VSP module 226 can utilize an FFT to convert time-domain input signal 602 to the frequency-domain. Plot 640 illustrates the four harmonics 622, 624, 626, 628 along a horizontal axis 640x representing frequency and a vertical axis 640y representing amplitude.

From plot 640, VSP module 226 can determine the following parameter values: (1) the number of harmonics of the input signal 602, (2) the frequency of each harmonic of input signal 602, and (3) the amplitude of each harmonic of input signal 602. Some or all of these parameter values can be compared to the corresponding parameter values for input signal 502 of FIGS. 5A-5C to detect harmonic deviation and, thus, a fault condition of the target system. For example, VSP module 226 may detect a deviation between the number of harmonics of input signal 602 (four harmonics) compared to input signal 502 (three harmonics). As another example, VSP module 226 may detect a deviation between the frequency of second harmonic 624 of input signal 602 compared to that of the second harmonic 524 of input signal 502. As another example, VSP module 226 may detect a deviation between the amplitude of second harmonic 624 of input signal 602 compared to that of second harmonic 524 of input signal 502. As previously discussed, VSP module 226 may utilize predetermine threshold values to determine whether a particular parameter deviation indicates a fault condition.

Of note, while existing sensors (e.g., rotation sensors) may compensate for harmonics to improve sensor accuracy, they do so using reference values that are preset in the factory or programmed by the customer (e.g., a trained operator/technician). In contrast, embodiments of the present disclosure can auto-calibrate harmonic reference parameter values.

It is appreciated herein that harmonic amplitude as obtained by an FFT is directly related to the number of samples and signal length (i.e., duration of time) provided as input to the FFT. Thus, in some embodiments. VSP module 226 may use substantially identical numbers of samples and signal lengths when detecting harmonic deviation. For example, during autocalibration, VSP module 226 may use a particular number of samples and signal length to detect the reference parameter values, and may subsequently use the same number of samples and signal length to detect harmonic deviation based on comparison of the reference parameter values.

In some embodiments, signal amplitude may be used as a vibration signature parameter for fault detection. It is appreciated herein that, for some target systems such as motor systems, the amplitude of a signal obtained from magnetic field sensing elements (e.g., signal 209a or signal 209b in FIG. 2) may be substantially constant during normal operation. As such, deviation in amplitude may indicate a fault such as an axial unbalance, or a broken ferromagnetic gear tooth or ring magnet magnetic pole.

In some embodiments, VSP module 226 may use peak-to-peak amplitude as a vibration signal parameter for fault detection. In more detail, VSP module 226 may implement a peak detector whereby it tracks the signal over one or more periods and calculates the peak-to-peak amplitude. In some embodiments, one or more of the techniques described in U.S. Pat. No. 11,029,176, issued on Jun. 8, 2021, and entitled “SYSTEM AND METHOD FOR VIBRATION DETECTION WITH NO LOSS OF POSITION INFORMATION USING A MAGNETIC FIELD SENSOR,” may be used to track magnetic signal peak-to-peak.

In addition to or as an alternative to peak-to-peak amplitude, VSP module 226 may use maximum amplitude, minimum amplitude, and/or root mean square (RMS) amplitude as parameters for fault detection. Multiple such parameters can be used to reduce the likelihood of false positives and to increase robustness.

VSP module 226 can detect signal amplitude during one or more periods of time, record the amplitude values to memory, and subsequently compare current signal amplitude to one or more recorded values to detect amplitude deviation. In some cases, VSP module 226 can do this for multiple different amplitude parameters, such as peak-to-peak amplitude, minimum amplitude, maximum amplitude, and RMS amplitude. In some cases, VSP module 226 may implement use bounded updates to avoid false amplitude changes due to noise (meaning that the peak signals are not updated to the exact peak value but instead to some predetermined percentage thereof). In some cases, the recording of the values may be done as part of an autocalibration process (such as the process shown in FIG. 9) and the values may be recorded to non-volatile memory (e.g., EEPROM) as reference values. In other cases, values may be recorded on an ongoing basis (e.g., after each bounded update period) and stored in non-volatile memory. In some cases, VSP module 226 may use a sliding window technique, recording the signal amplitude detected over the past P update periods and comparing current signal amplitude to one or more of the past P recorded amplitude values (or, in some cases, an average thereof).

In any case, VSP module 226 can compare detected signal amplitude can be compared with one or more previously recorded values to detect amplitude deviation and a potential fault condition. In some embodiments, VSP module 226 may calculate a difference between a current amplitude and a past amplitude and compare the difference to a predetermined threshold value to determine if a fault exists.

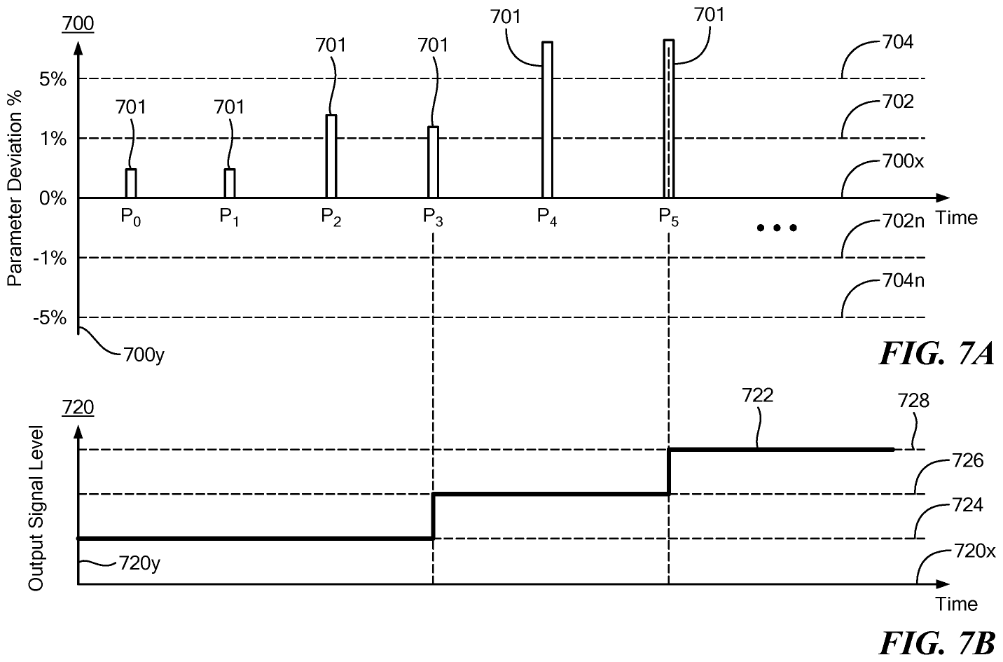

FIG. 7A illustrates how a particular vibration signature parameter can be tracked over multiple time periods and how multiple threshold values can be used for fault detection, according to embodiments of the disclosure. The illustrated techniques can be applied to any or all of the parameters described herein above (e.g., speed, phase difference, number of harmonics, harmonic frequencies, harmonic amplitudes, and signal amplitude). The illustrated techniques can be implemented within and performed by a sensor, such as sensor 200 of FIG. 2 and more particularly VSP module 226 of FIG. 2.

Plot 700 has a horizontal axis 700x representing time and a vertical axis 700y representing the deviation between the parameter's detected value and its reference value, expressed as a percentage. Any of the parameter detection techniques described above may be used to detect the parameter's value, and the deviation can be calculated using equation (1), for example.

Parameter deviation 701 may be calculated on a periodic basis, for example at times P₀, P₁, P₂, . . . , shown in the figure. In some cases, parameter deviation can be recalculated (or “updated”) at a rate equal to, or approximately equal to, the frequency of the signal used as input to the parameter detection algorithm. For example, the time between P₀ and P₁ can be approximately equal to the period of input signal 302 in FIG. 3. In other applications, parameter deviation can be recalculated at a rate faster than, or slower than the frequency of the input signal. For example, a parameter update period may be a multiple of the signal period.

Parameter deviation 701 can be compared to one or more predetermined threshold values. In the example of FIG. 7A, two threshold values 702 and 704 are shown, corresponding to parameter deviation of 1% and 5%, respectively. These threshold values are merely illustrative and other threshold values can be preset/programmed on the sensor. In some cases, parameter deviation can be converted to an absolute value before being compared to a threshold value such that a sufficiently large deviation in either the positive or negative direction results in a detected fault. Alternatively, one or more negative threshold values can be preset/programmed on the sensor. For example, in FIG. 7A, negative threshold values 702n and 704n are shown, corresponding to parameter deviation of −1% and −5%, respectively.

During each update period (e.g., at times P₀, P₁, P₂, . . . ), parameter deviation 701 can be compared to threshold values 702, 704. If the deviation 701 (or, in some cases, the absolute value thereof) is greater than a threshold value 702, 704 (or, in some cases, less than a negative threshold value 702n, 704n) for C consecutive periods, then the sensor may output a fault indication. The number of consecutive periods C may be preset or programmed on the sensor, such as within EEPROM. As one example, C=2. In some embodiments, the sensor may store the past detected parameter values, or parameter deviations, in memory such that it can determine if a particular threshold value is exceeded for C consecutive periods.

Different threshold values may be associated to different levels of severity (or “warning levels”). For example, first threshold value 702 may be associated with a low severity fault condition whereas second threshold value 704 may be associated with high severity fault condition. As described next, in some cases, the sensor can generate and output a fault signal indicating a particular severity level, enabling operators to prioritize their maintenance efforts.

FIG. 7B illustrates an output communication protocol that can be used by a sensor to indicate a fault of a target system, according to embodiments of the disclosure. The illustrated protocol is a 3-level (N=3) protocol. In other examples, a binary (N=2) communication protocol may be used. In still other examples, a N>3-level protocol may be used.

Illustrative plot 720 has a horizontal axis 720x representing time and a vertical axis 720y representing current/voltage level of a generated fault signal 722. At a given point in time, fault signal 722 can have a first level 724, a second level 726, or a third level 728. That is, sensor circuitry can generate fault signal 722 to have levels 724, 726, or 728 based on the result of one or more fault detection techniques. In the case where levels 724, 726, 728 represent different current levels, fault signal 722 may be generated by an output current generator, such as generator 212 of FIG. 2.

Referring to the combined example of FIGS. 7A and 7B, fault signal 722 can have first level 724 at times P₀. P₁, and P₂ when parameter deviation 701 is below threshold values 702, 704 and above threshold values 702n, 704n. At time P₃ the parameter deviation 701 exceeds first threshold level 702, however fault signal 722 stays at first level 724 until time P₃ when the deviation exceeds first threshold level 702 for C=2 consecutive update periods. At this point, fault signal 722 has second level 726. At time P₅ the parameter deviation 701 has exceeded second threshold value 704 for C=2 consecutive update periods and, as a result, fault signal 722 has third level 728.

In some embodiments, a sensor may associate different threshold values to different signal levels, and use these associates to generate fault signal 722. For example, first threshold level 702 may be associated with second signal level 726 and second threshold level 704 may be associated with third signal level 728, where the first signal level 724 is a default signal level. Such associations may be fixed within the sensor, or programmed within an EEPROM or other non-volatile memory.

The general techniques illustrated by FIGS. 7A and 7B can be applied to an arbitrary number of vibration signature parameters. For example, for each of a plurality of parameters, the sensor can calculate the parameter's deviation and compare the deviation to one or more threshold values. If any of the parameters has a deviation (or an absolute value thereof) that exceeds an associated threshold value, then the sensor can output a fault indication (e.g., by varying the level of fault signal 722). Otherwise, if no parameter's deviation exceeds an associated threshold value, then the sensor can output a no-fault indication. In the case where multiple threshold values are defined (e.g., programmed in EEPROM), sensor can output a fault level corresponding to the highest threshold value exceeded by any parameter.

FIGS. 7, 8, and 9 illustrate processing that may be performed by a sensor configured to perform fault detection, such as sensor 200 of FIG. 2. The various blocks shown in the flow diagrams of FIGS. 7, 8, and 9 may be performed in an order other than shown.

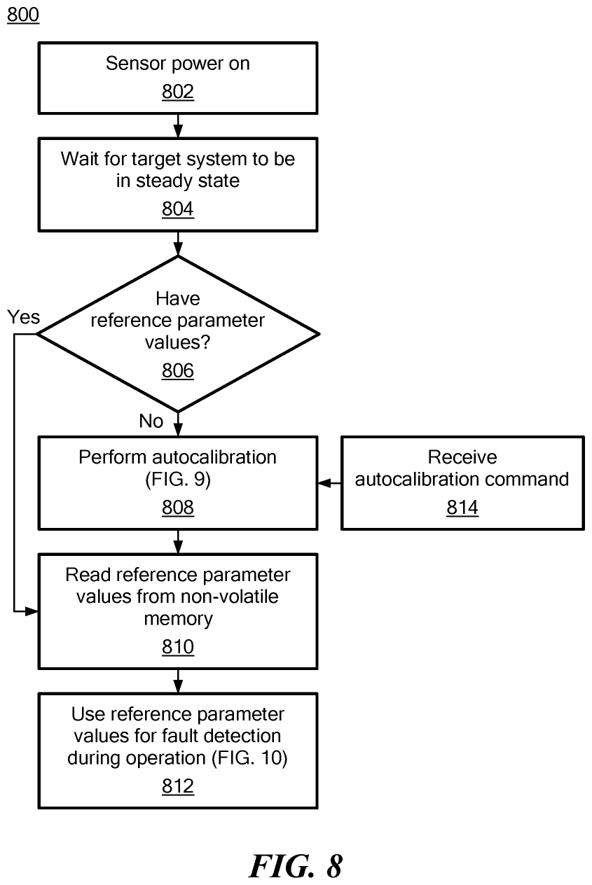

FIG. 8 illustrates overall operation of the sensor, according to embodiments of the disclosure. A process 800 can begin when the sensor is powered on, at block 802.

At block 804, process 800 can wait for the target system to be in a steady state. In some embodiments, this can include waiting a predetermined amount of time or a predetermined number of signal periods to ensure the target system is in a steady state. For example, the sensor may wait for at least C update periods to occur. In some embodiments, block 804 can include waiting for one or more detected system parameters to become stable over a number of consecutive update periods (e.g., at least C consecutive periods). For example, block 804 may wait for the target system speed to be substantially constant over consecutive update periods, where the speed can be detected using the techniques described above in the context of FIG. 3. In any case, block 804 can utilize a delay/timer circuit to periodically check if the target system is in a steady state.

At block 806, it is determined whether the sensor has access to reference parameter values. For example, the sensor can attempt to read the reference values from non-volatile memory.

If one or more reference parameter values is not stored in non-volatile memory or otherwise not accessible to the sensor, the sensor may perform autocalibration at block 808. This can occur, for example, the first time the sensor is powered on (i.e., starts up). In other words, time first time the sensor is powered it, it may not have any reference parameter values that it can use for fault detection and must detect the initial reference parameter values. These values are written memory and subsequently referenced as the “normal” state of health of the target system. An illustrative autocalibration process that may be used is described below in the context of FIG. 9. Otherwise, if all reference values are available for all vibration signature parameters, the sensor proceed to directly block 810, as shown.

At block 810, the sensor can read the reference parameter values from non-volatile memory. The reference values may correspond to new reference values detected via the preceding autocalibration block 808, or values detected during an earlier calibration. In the latter case, the reference values may have already been read at block 806, in which case block 810 may be skipped.

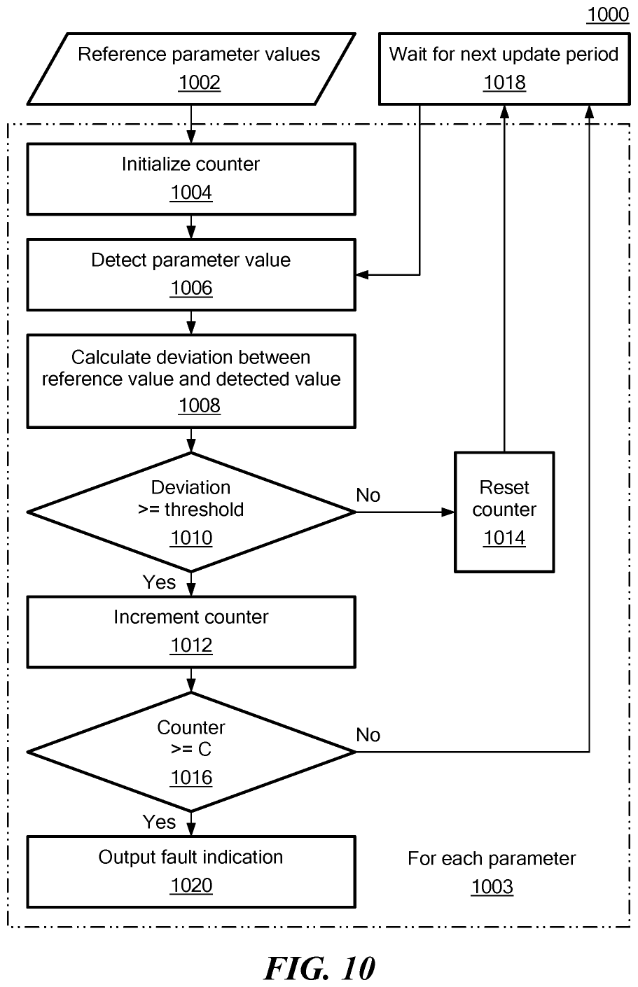

At block 812, the sensor may utilize the reference values for fault detection. FIG. 10 shows an example of processing that may be performed at block 810.

During operation of the sensor, a user may issue an autocalibration command via an industrial maintenance box or other external system/device connected to the sensor. For example, a technician may issue an autocalibration command after replacing one or more components of the target system, as this may cause the system's vibration signature to change. At block 814, in response to receiving such a command, the sensor may perform autocalibration at block 808, as shown.

FIG. 9 shows an example of a process 900 for auto-calibrating reference parameter values used for fault detection by a sensor, according to embodiments of the disclosure. Autocalibration process 900 may be initiated, for example, the first time the sensor starts up and/or in response to a user-issued autocalibration command.

At block 902, existing reference parameter values can be read from non-volatile memory. Of note, it is expected that one or more parameter reference values may not exist in non-volatile memory. For example, during the first startup of the sensor, no reference values will be stored in non-volatile memory.

Next, the group of blocks 903 may be performed separately for each vibration signature parameter used for fault detection by the sensor (e.g., target object speed, a phase difference between two signals, signal harmonics, signal amplitude, etc.). In some cases, the group of blocks 903 may be performed for multiple parameters in series. In other cases, it may be performed in parallel for different parameters.

At block 904, the value of a given parameter can be detected using a corresponding technique described hereinabove.

If, at block 906, a reference value exists for the parameter (e.g., the sensor was previously auto-calibrated), then process 900 can proceed to blocks 908-912. Otherwise, process 900 may skip to block 914, as shown.

At block 908, a deviation between the parameter's detected and existing reference values can be calculated. In some embodiments, the deviation may be calculated as a percentage using, for example, equation (1). In some cases, the deviation may be calculated as an absolute value.

At block 910, the parameter deviation can be compared to a predetermined threshold value set for the parameter. In some cases, block 910 can include reading a programmable threshold value from non-volatile memory. In some cases, the threshold value may be a percentage. Of note, the threshold value(s) used by autocalibration process 900 may be different from those used for fault detection during operation (e.g., used by process 1000 of FIG. 10). In some cases, the autocalibration threshold value(s) may be larger.

If the parameter deviation is greater than or equal to the predetermined threshold value, then, at block 912, the sensor can output an indication that autocalibration has failed. For example, the sensor can generate an output signal having a current/voltage level indicating an autocalibration failure. In some cases, an autocalibration failure can be communicated on the same output port used for communicating faults detected during operation. In other cases, separate output ports may be used. In some embodiments, the sensor can output additional diagnostic information, such as identifying the specific vibration signature parameter for which autocalibration failed. In any case, if the deviation exceeds the threshold, the newly detected parameter value may be discarded (e.g., not written to non-volatile memory). Otherwise, if the deviation between the detected value and reference value is less than the predetermined threshold value, process 900 can proceed to block 914.

Some non-volatile memory devices/circuits, such as EEPROM, may have a range of temperatures within which they are designed to operate, and may exhibit unreliable behavior outside of that designed operating range. Thus, in some embodiments, autocalibration process 900 may determine whether the sensor's temperature is within a specified range before attempting to write a new reference value to non-volatile memory. This temperature range may be hardcoded or otherwise specified within the sensor. The specified temperature range may correspond to the full range of temperatures expected for a given sensing application (e.g., automotive application) or a narrower range due to EEPROM programming constraints.

At block 914, the temperature of the sensor can be determined using, for example, a signal received from an on-device temperature sensor (e.g., temperature sensor 214 of FIG. 2). At block 916, if the sensor's temperature is specified range, then, at block 918, the detected value may be stored/written to non-volatile memory as the new reference value for that parameter. In the case where process 900 is being used to re-calibrate the vibration signature parameters, a previous reference value may be overwritten by the new value. Otherwise a new reference value may be stored.

If, at 916, the sensor's temperature is outside of the specified range, then process 900 may wait for the temperature to increase/decrease before storing the new reference value, as represented by line 920. In some embodiments, process 900 can utilize delay/timer circuit to periodically check if the sensor's temperature is within the specified range.

FIG. 10 shows an example of a process 1000 for fault detection that can be performed by a sensor during operation, according to embodiments of the disclosure. As input, process 1000 can receive reference values 1002 for one or more vibration signature parameters used for fault detection by the sensor. The reference values 1002 can be read from non-volatile memory at sensor startup or following autocalibration.

The group of blocks 1003 may be performed separately for each vibration signature parameter, either in series or in parallel for different parameters.

As discussed above in the context of FIGS. 7A and 7B, a sensor can detect a fault of a target system when a given vibration signature parameter deviates from its reference value by more than a threshold value for C consecutive update periods, where C is a predetermined value fixed or programmed into the sensor. To enable this, parameter-specific counters can be maintained by process 1000.

At block 1004, the parameter-specific counter can be initialized (e.g., set to zero). In some embodiments, the counter may be stored in volatile memory of the sensor.

At block 1006, the parameter value can be detected using a corresponding detection technique described hereinabove.

At block 1008, the deviation between the detected and reference parameter values can be calculated. In some embodiments, the deviation may be calculated as a percentage using, for example, equation (1). In some cases, the deviation may be calculated as an absolute value.

At block 1008, the parameter deviation can be compared to a predetermined threshold value associated with the parameter. If the deviation is greater than or equal to the threshold value, then, at block 1012, the counter can be incremented (e.g., by one). After being incremented, if the counter is greater than or equal to C, then the sensor can output a fault indication at block 1020. In some cases, block 1020 may including generating a fault signal having a voltage/current level that indicates a fault condition, such as using the output communication protocol illustrated in FIG. 7B. Otherwise, if the counter is less than C, then the process may proceed to block 1018, as shown.

Returning to block 1010, if the calculated parameter deviation is less than the threshold value, then the counter can be reset (e.g., to zero), at block 1014, and processing may continue to block 1018.

At block 1018, the sensor may wait for the next update period before repeating from block 1006. As previously discussed, the length of an update period may be based on the period of a signal used as input to parameter detection algorithm (e.g., input signal 302 in FIG. 3). In some embodiments, the sensor can use a single update period for all vibration signature parameters. In other embodiments, different update periods may be used for detecting different parameters.

As previously discussed, in some embodiments a sensor can store multiple threshold values and determine a fault/warning level for the target system based on comparing the parameter deviation to different ones of the threshold values. Thus, in some cases, process 1000 may be adapted to allow for multiple threshold values. For example, block 1010 can be modified such that the calculated parameter deviation is compared with each of the multiple threshold values, proceeding to block 1012 if any of the threshold values are exceeded. As another example, block 1020 may be adapted to generate an output signal according to an N-level (N>2) communication protocol, where the output signal level indicates the highest threshold value exceeded by the parameter deviation.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method for determining a fault status of a target system, the method comprising:
receiving one or more magnetic field signals sensed by one or more magnetic field sensing elements of a sensor, the one or more magnetic field signals responsive to a magnetic field generated by a target object of the target system, the target object having repetitive motion;
processing the one or more magnetic field signals to detect values of one or more parameters indicative of vibration of the target system;
calculating deviations between the detected values and corresponding reference values of one or more parameters;
determining a fault level of the target system based on the calculated deviations of one or more parameters; and
generating an output signal indicating to the fault level.

2. The method of claim 1, wherein the target system includes a motor system.

3. The method of claim 2, wherein the target object includes a rotating shaft having a ring magnet to generate the magnetic field.

4. The method of claim 2, wherein the target object includes a rotating gear having ferromagnetic teeth to generate the magnetic field.

5. The method of claim 1, wherein the determining of the fault level of the target system includes:
comparing the calculated deviations of one or more parameters to corresponding predetermined threshold values.

6. The method of claim 5, wherein the determining of the fault level of the target system further includes:
determining the fault level of the target system to be a first fault level if none of the calculated deviations is greater than or equal to a corresponding predetermined threshold value; and
determining the fault level of the target system to be a second fault level if at least one of the calculated deviations is greater than or equal to the corresponding predetermined threshold value.

7. The method of claim 5, wherein at least one of the parameters has two or more corresponding predetermined threshold values, wherein the determining of the fault level of the target system further includes:
determining the fault level of the target system to be a first fault level if the calculated deviation of the at least one of the parameters is less than a first corresponding predetermined threshold value;
determining the fault level of the target system to be a second fault level if the calculated deviation of the at least one of the parameters is greater than or equal to the first corresponding predetermined threshold value and less than a second corresponding predetermined threshold value; and
determining the fault level of the target system to be a third fault level if the calculated deviation of the at least one of the parameters is greater than or equal to the second corresponding predetermined threshold value.

8. The method of claim 1, further comprising auto-calibrating the reference values of one or more parameters.

9. The method of claim 8, wherein the auto-calibrating of the reference values is responsive to a first startup of the sensor.

10. The method of claim 8, wherein the auto-calibrating of the reference values is responsive to a user command.

11. The method of claim 8, wherein the auto-calibrating the reference values of one or more parameters includes:
processing the one or more magnetic field signals to detect the reference values of one or more parameters; and
storing the reference values to non-volatile memory of the sensor.

12. The method of claim 11, further comprising:
receiving a signal responsive to a temperature of the sensor,
wherein storing the reference values to non-volatile memory of the sensor is responsive to a determination that the temperature of the sensor is between a predetermined range of temperatures.

13. The method of claim 1, wherein the one or more parameters include a parameter indicative of a speed of the target object, wherein the processing of the one or more magnetic field signals to detect the values of the one or more parameters includes:
generating pulses responsive to amplitude of the one or more magnetic field signals; and
incrementing a counter at a fixed rate between edges of the pulses to detect the speed of the target object.

14. The method of claim 1, wherein the receiving of the one or more magnetic field signals sensed by the one or more magnetic field sensing elements of the sensor includes receiving a first magnetic field signal sensed by a first magnetic field sensing element and receiving a second magnetic field signal sensed by a second magnetic field sensing element, wherein the one or more parameters include a parameter indicative of a phase difference between the first and second magnetic field signals, wherein the processing of the one or more magnetic field signals to detect the values of the one or more parameters includes:
generating a first phase signal responsive to a phase of the first magnetic field signal;
generating a second phase signal responsive to a phase of the second magnetic field signal; and
calculating the phase difference between the first and second magnetic field signals based on a comparison of the first and second phase signals.

15. The method of claim 1, wherein the one or more parameters include one or more parameters representing harmonics of the target system, wherein the processing of the one or more magnetic field signals to detect the values of the one or more parameters includes:
transforming the one or more magnetic field signals into a frequency domain to determine the one or more parameters representing the harmonics of the target system.

16. The method of claim 1, wherein the one or more parameters representing harmonics of the target system include:
a number of the harmonics;
frequencies of the harmonics; and
amplitudes of the harmonics.

17. The method of claim 1, wherein the one or more parameters include a parameter indicative of an amplitude of the one or more magnetic field signals.

18. A sensor comprising:
one or more magnetic field sensing elements;
a circuit configured to:
receive one or more magnetic field signals sensed by the one or more magnetic field sensing elements, the one or more magnetic field signals responsive to a magnetic field generated by a target object of a target system, the target object having repetitive motion;
process the one or more magnetic field signals to detect values of one or more parameters indicative of vibration of the target system;
calculate deviations between the detected values and corresponding reference values of one or more parameters;
determine a fault level of the target system based on the calculated deviations of one or more parameters; and
generate an output signal indicating to the fault level.

19. The sensor of claim 18, wherein the determining of the fault level of the target system includes:
comparing the calculated deviations of one or more parameters to corresponding predetermined threshold values.

20. The sensor of claim 19, wherein the determining of the fault level of the target system further includes:
determining the fault level of the target system to be a first fault level if none of the calculated deviations is greater than or equal to a corresponding predetermined threshold value; and
determining the fault level of the target system to be a second fault level if at least one of the calculated deviations is greater than or equal to the corresponding predetermined threshold value.
